(19) United States
(12) Patent Application Publication
(10) Pub. No.: US 2009/0065995 A1
(43) Pub. Date: Mar. 12, 2009

(54) Ambidexturous Shuttle Spoon

(75) Inventor: Jose Manuel Pimentel Serrano, Fountain, CO (US)

Correspondence Address: FISH & RICHARDSON P.C., PO BOX 1022, MINNEAPOLIS, MN, 55440-1022, US

(73) Assignee: ATMEL Corporation

(21) Appl. No.: 11/853,727

(22) Filed: Sep. 11, 2007

(51) Int. Cl. B23Q 3/00

(52) U.S. Cl. 269/290; 294/1.1

(57) ABSTRACT

The present disclosure includes, among other things, an ambidextrous shuttle spoon.

### BACKGROUND

This specification relates to a semiconductor wafer handling apparatus.

A shuttle spoon is a mechanical tool that is used to transport semiconductor wafers to and from wafer cassettes during manufacturing. FIG. 1A depicts the top side of a typical shuttle spoon. Wafers are carried on the semi-circular portion 1. Section 2 of the shuttle spoon is connected to a wafer handling system. The bottom side of the shuttle spoon depicted in FIG. 1A is shown in FIG. 1B. The bottom side is not used for carrying wafers. Shuttle spoons are typically manufactured with either a left-handed mount (FIG. 1A) or a right-handed mount, depending on the configuration required by a particular wafer handling system.

Semiconductor fabrication plants may have a mix of wafer handling systems, some of which only work with left-handed mount shuttle spoons and some of which only work with right-handed mount shuttle spoons. Because shuttle spoons can become damaged, spares need to be kept on hand. Since both left and right-handed shuttle spoons may be required, the number of spare shuttle spoons needed can be twice as much as would be required if only one configuration of shuttle spoon was used. Moreover, typical shuttle spoons are made of materials that are prone to bend or deform. Use of such shuttle spoons can result in wafer handling errors and puts wafers at risk of being damaged.

### SUMMARY

In general, one or more aspects of the subject matter described in this specification can be embodied in an ambidextrous shuttle spoon for a semiconductor wafer handling apparatus, the spoon comprising a first surface comprising a proximal mounting body portion and a semi-circular distal wafer support portion, the mounting body portion including one or more first mounting elements distributed thereon for coupling to a wafer handling system and the wafer support portion including a plurality of first support structures for supporting a wafer. A second surface is located on the first surface's underside and coextensive with the first surface, the second surface including second mounting elements identical to the first mounting elements and second support structures identical to the first support structures. The corresponding first and second mounting elements are in alignment with each other and corresponding first and second support structures are in alignment with each other. Other embodiments are disclosed.

Particular embodiments of the subject matter described in this specification can be implemented to realize one or more of the following advantages. The shuttle spoon has been redesigned to consolidate all the characteristics for both left and right-handed mounts into one single ambidextrous part. The new design can reduce storage inventory of shuttle spoons. The shuttle spoon composition material is rigid to eliminate the possibility of bending the part. The cost for producing the shuttle spoon can be lower than typical production costs.

The details of one or more embodiments of the subject matter described in this specification are set forth in the accompanying drawings and the description below. Other features, aspects, and advantages of the invention will become apparent from the description, the drawings, and the claims.

### BRIEF DESCRIPTION OF THE DRAWINGS

FIG. 1A depicts the top side of a prior art left-handed shuttle spoon.

FIG. 1B depicts the bottom side of a prior art left-handed shuttle spoon.

FIGS. 2A-C depict an example ambidextrous shuttle spoon.

FIG. 3 depicts an example ambidextrous shuttle spoon with a left-handed mount.

FIG. 4 depicts an example ambidextrous shuttle spoon with a right-handed mount.

FIG. 5 depicts an example configuration of mounting elements.

FIG. 6 depicts a further example configuration of mounting elements.

FIG. 7 depicts a semiconductor wafer being carried on an example ambidextrous shuttle spoon.

FIG. 8 depicts an example semiconductor wafer resting on an example support structure.

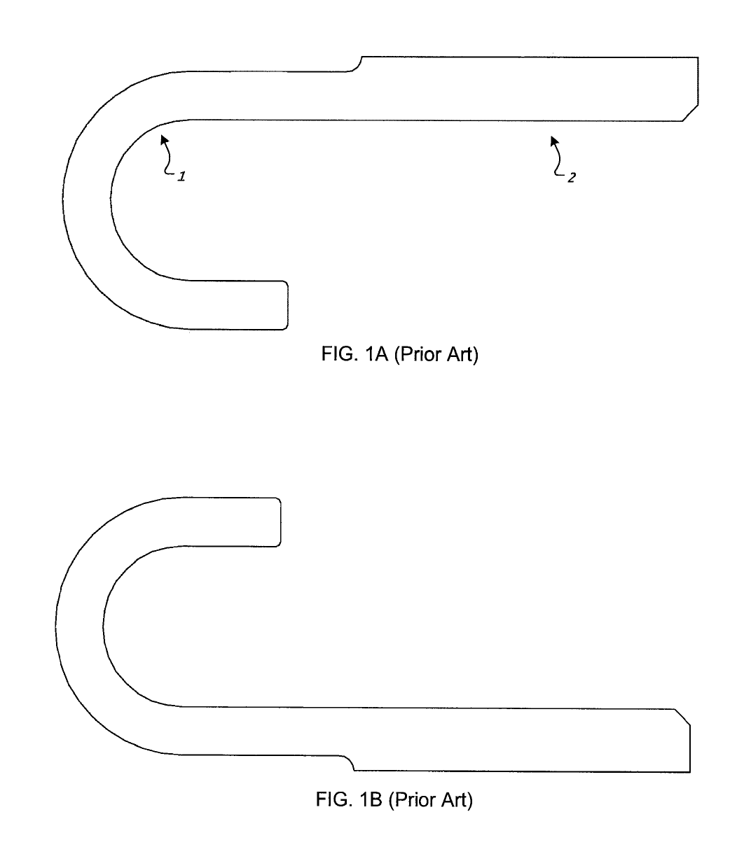

Like reference numbers and designations in the various drawings indicate like elements.

### DETAILED DESCRIPTION

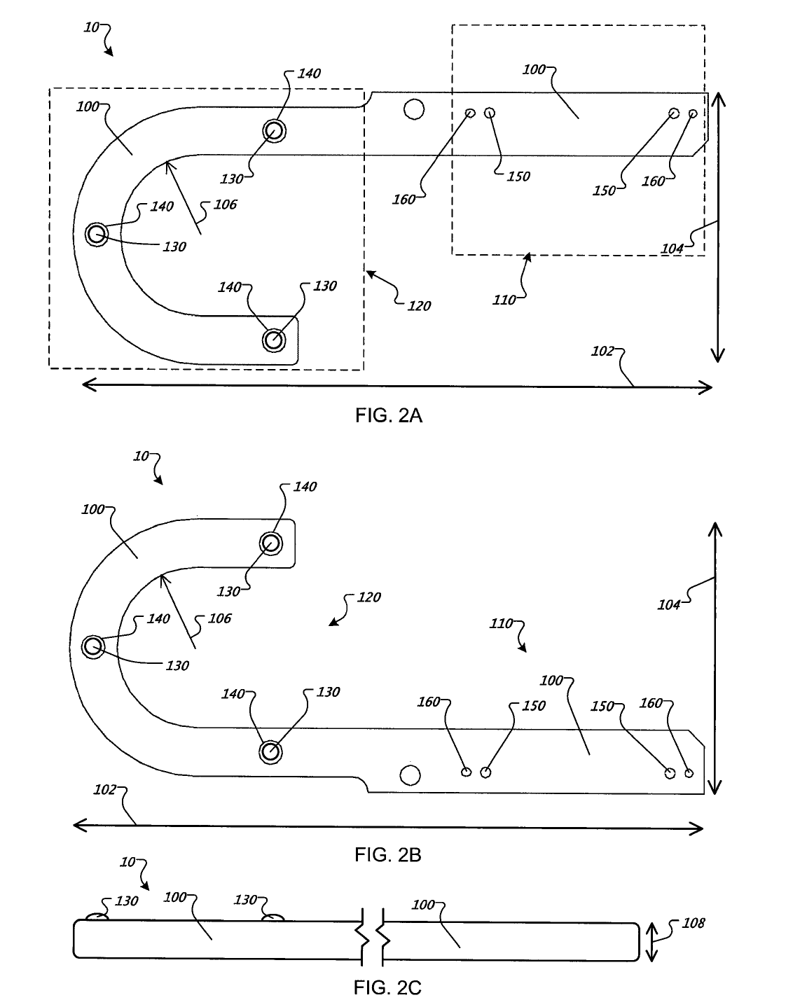

Referring to FIGS. 2A-C, an ambidextrous shuttle spoon 10 can be used in a semiconductor wafer handling system. The shuttle spoon 10 may include a spoon body 100, a proximal mounting body portion 110 which may be used to mount the spoon 10 to a wafer handling system, and a semi-circular distil wafer support portion 120. In some embodiments, a semiconductor wafer can be located on top of the wafer support portion 120, and be translated by horizontal motion of the shuttle spoon 10. While positioned on top of the wafer support portion 120, a wafer may rest on a plurality (e.g., three) of support structures. In various embodiments, the support structures are projections such as protuberances or friction pads 130, for example, located in friction pad recesses 140. The friction pads 130 can support the wafer and minimize horizontal movement of the wafer relative to the shuttle spoon 10. The shuttle spoon 10 can be removably attached to a wafer handling system by use of mounting elements. In various embodiments, the mounting elements include one or more of alignment holes, mounting holes, raised edges, protuberances, depressions, and cavities. For example, the shuttle spoon 10 can be removably attached to a wafer handling system by screws installed through mounting holes 150 in the spoon body 100. Prior to installation of screws into the mounting holes 150, the shuttle spoon 10 can be positioned on a wafer handling system such that alignment pins become located on the interior of alignment holes 160. Once the shuttle spoon is positioned on a wafer handling system such that the alignment pins are located in the alignment holes 160, screws can be installed through the mounting holes 150 into the wafer handling system, thus removably attaching the shuttle spoon 10 to the wafer handling system.

In some embodiments, the spoon body 100 can be made from a single piece of material (e.g., a single piece of aluminum). Due to the delicate nature of semiconductor wafers, it is desirable that a shuttle spoon be straight and not deform over time or deform due to stresses (e.g., from the weight of the wafer) that may be placed on it. If a shuttle spoon does deform, even a small amount that may not be readily noticeable, this slight deformation can damage wafers leading to rejects. If the slight deformation goes unnoticed, many wafers can be damaged in this manner. For this reason, the spoon body 100 can comprise a stiff, brittle material such as a ceramic, which would resist deformation. In alternate embodiments, the spoon body 100 can be made of other materials such as, stainless steel, aluminum, graphite, tungsten, molybdenum, or a polyimide (e.g., Dupont Vespel). While the spoon body 100 described here is a single piece made from a single material (e.g., a ceramic), it should be clear to someone skilled in the art that the spoon body 100 could be assembled from more than one sub-component and that it could comprise any one or more of the materials described, or other materials suitable for use in the semiconductor industry.

Still referring to FIG. 2A-2C, the shuttle spoon 10 can have an overall length 102 of, for example, 10.0 inches, while the width 104 of the shuttle spoon 10 can be 4.23 inches. The interior radius of curvature 106 of the wafer support portion 120 can be 1.25 inches, while the overall thickness 108 of the shuttle spoon 10 can be 0.59 inches. In some embodiments, the distil wafer support portion 120 of the spoon body 100 can include three friction pad recesses 140 which are round with a diameter of 0.37 inches, have flat bottoms, and are 0.2 inches deep. Located within each of the friction pad recesses 140 are friction pads 130 which are round with a diameter of 0.32 inches, have a domed top, and are 0.60 inches thick. The proximal mounting body portion 110 of the spoon body 100 can include two mounting holes 150 (each 0.169 inches in diameter) and two alignment holes 160 that are 0.126 inches in diameter.

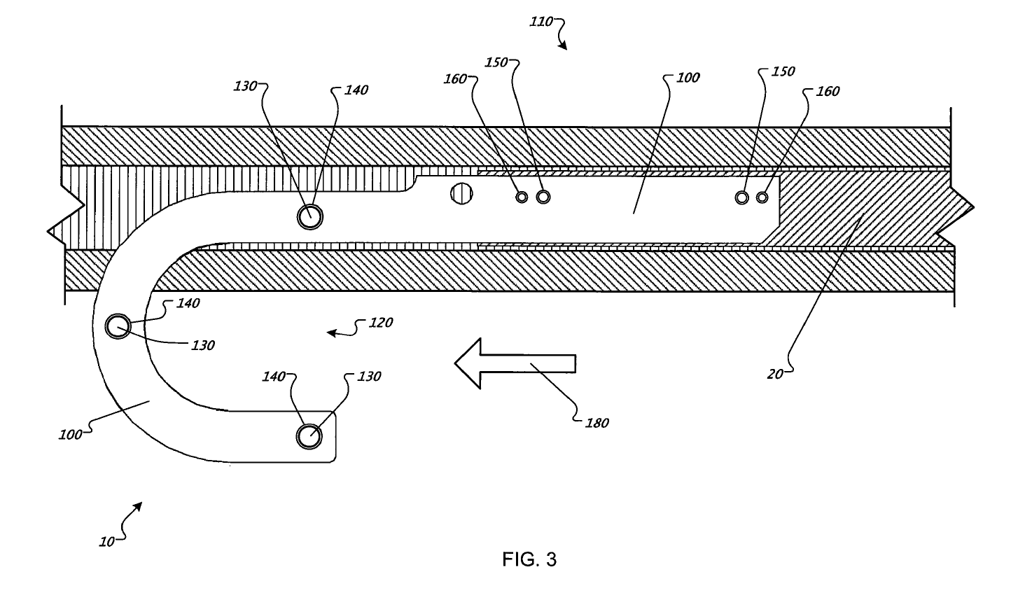

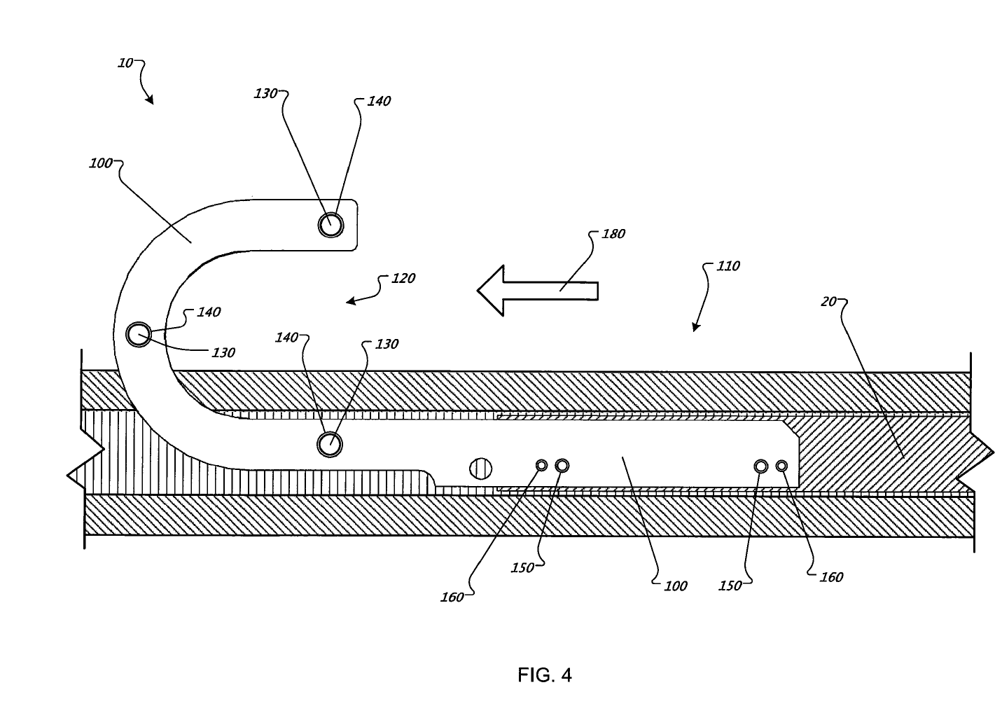

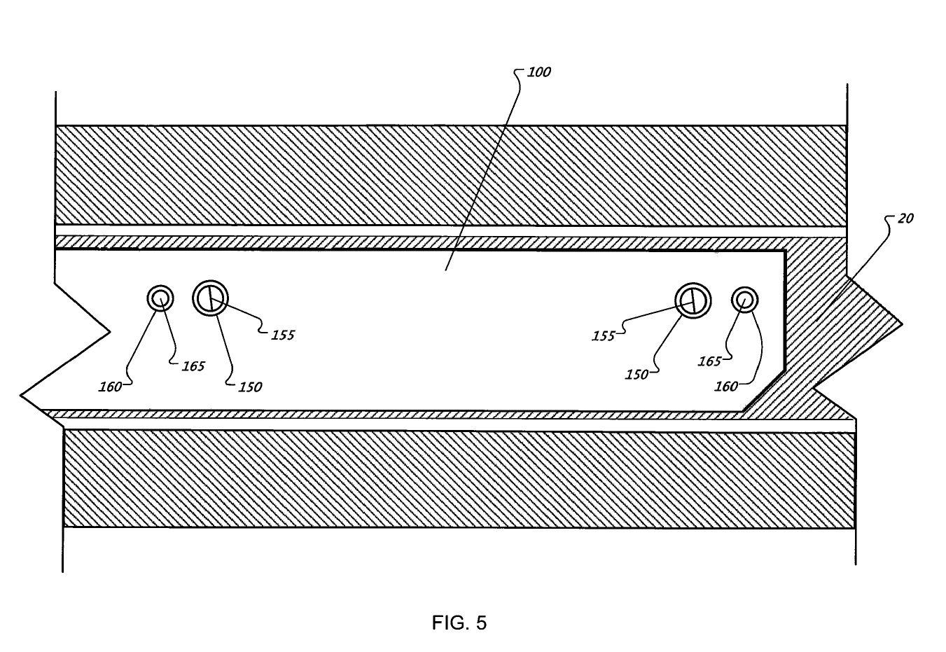

As described previously, the shuttle spoon 10 can be used in a wafer handling system, such as found in the Kestrel high energy ion implant system. Referring to FIGS. 3-5, some embodiments of the shuttle spoon 10 can be attached to a wafer handling system by first positioning the spoon body 100 such that alignment pins 165 (FIG. 5) are located in the interior of the alignment holes 160. The alignment pins 165 can be integral to a shuttle spoon mount 20 that is part of a wafer handling system. Some embodiments of the shuttle spoon 10 can be mounted to a wafer handling system in an ambidextrous manner (e.g., using either a left-handed or a right-handed mount) allowing it to be used in either orientation. FIG. 3 depicts the shuttle spoon 10 mounted on the left side of a shuttle spoon mount 20 (left-handed mount), while FIG. 4 depicts the shuttle spoon 10 mounted on the right side of a shuttle spoon mount 20 (right-handed mount). Referring to FIG. 5, once positioned on the mount 20, the shuttle spoon 10 can be removably attached to the wafer handling system, for example, using mounting screws 155 inserted through the mounting holes 150 and secured into corresponding threaded holes in the mount 20. While the embodiment depicted here contains two alignment holes 160, two alignment pins 165, two mounting holes 150, and two mounting screws 155 any number of these features could be present and be used to removably secure the shuttle spoon 10 to a wafer handling system.

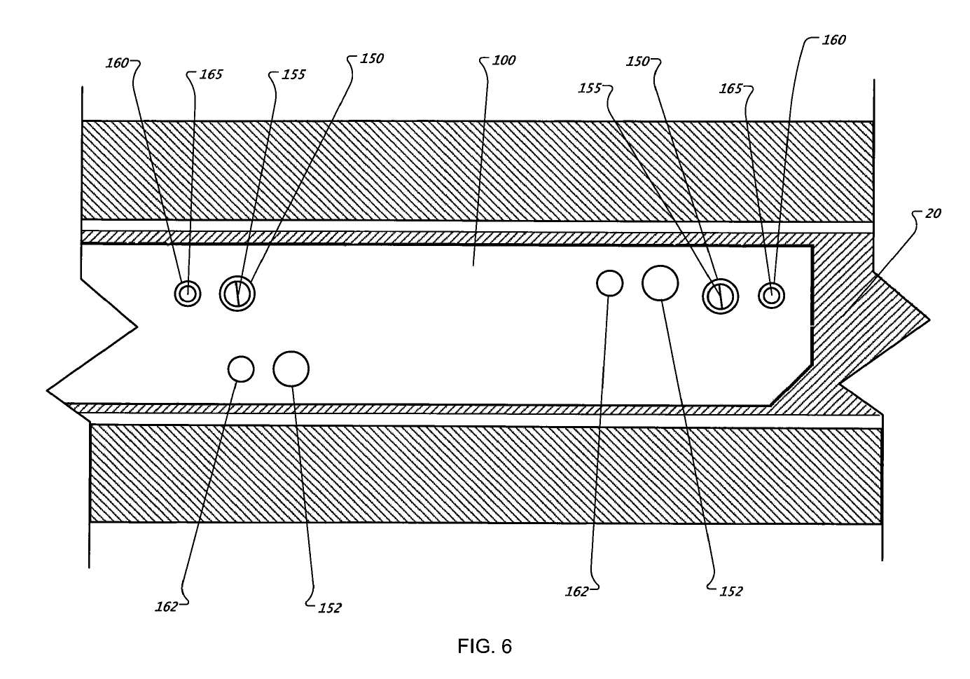

In alternate embodiments, the shuttle spoon 10 could be designed to be compatible with a plurality of wafer handling systems. In these embodiments, the spoon body 100 could have more than two alignment holes 160 and more than two mounting holes 150 to accommodate alignment pins and threaded holes that are different sizes and in different locations on a plurality of wafer handling devices. In one example (depicted in FIG. 6), a spoon body 100 could have wafer handling system A alignment holes 160 and wafer handling system A mounting holes 150, and wafer handling system B alignment holes 162 and wafer handling system B mounting holes 152. When mounted to wafer handling system A (shown in FIG. 6), corresponding alignment pins 165 are located inside the alignment holes 160 and screws 155 are inserted through the mounting holes 150 and subsequently secured to the wafer handling system. When mounted in wafer handling system B (not shown), corresponding alignment pins are located inside the alignment holes 162 and screws are inserted through the mounting holes 152. In still additional embodiments (not shown), the wafer handling system may not have alignment pins or screw holes at all. In these cases, the wafer handling system could include threaded studs. When the shuttle spoon 10 is positioned on a wafer mount, the threaded studs can be located in and protrude from the mounting holes 150 such that, for example, a nut can be assembled on to the threaded studs and tightened, thus removably securing the shuttle spoon 10 to a wafer mount without the need for alignment pins.

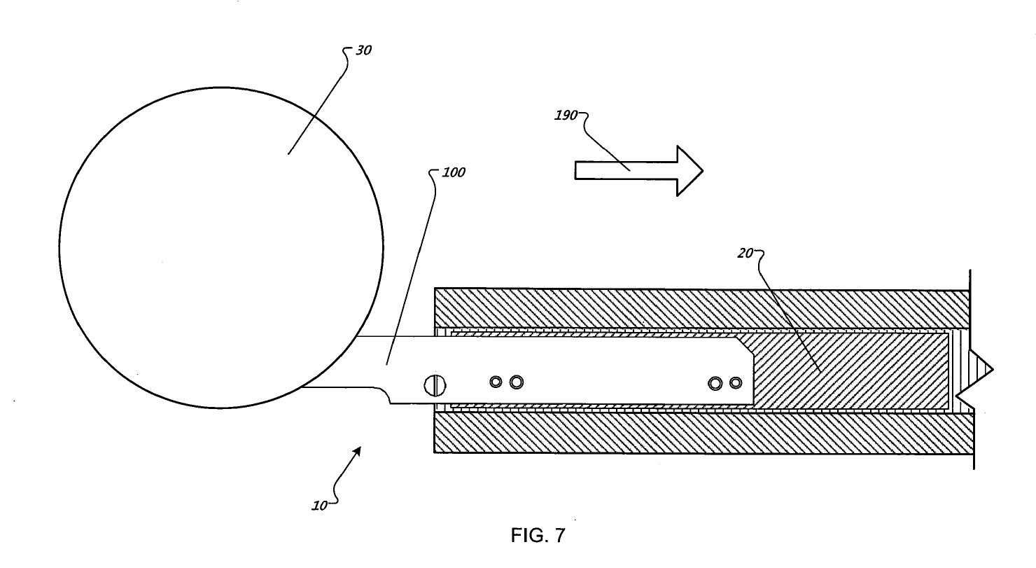

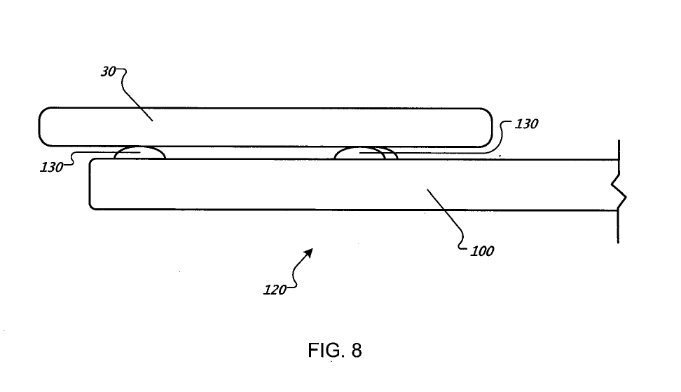

Referring to FIG. 7, the shuttle spoon 10 can be designed to be removably attached to the wafer handling module of a Varian End Station and subsequently used to transport wafers (e.g., 6 inch wafers) to and from a cassette, thus making them available to other aspects of the wafer handling system (e.g., a robotic arm). In alternate embodiments, the shuttle spoon 10 could be manufactured with other dimensions for use in additional Varian systems (e.g., E220, E500, and the like), for use in systems produced by other manufacturers, and/or with other wafer sizes (e.g., 4 inch, 8 inch, and the like). In use, the shuttle spoon can extend in a horizontal direction 180 (FIG. 4) such that the distil wafer support portion 120 enters a wafer containing cassette. Once the portion 120 is located inside the cassette, an elevator can lower, thus positioning a wafer 30 on the distil wafer support portion 120 of the shuttle spoon 10 (FIG. 7). As shown in FIG. 8, the wafer can be positioned such that it rests on and is supported by the friction pads 130 located in the friction pad recesses 140. Once the wafer 30 has been located on the friction pads 130, the shuttle spoon 10 can retract in a horizontal direction 190, thus removing the wafer 30 from the cassette. Once external to the cassette, the wafer 30 can be further processed (e.g., picked up by a robotic arm and moved to another location). While FIG. 7 depicts the shuttle spoon 10 in a left-handed mount, the shuttle spoon 10 can perform similar tasks when in a left-handed mount.

While this specification contains many implementation details, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, the actions recited in the claims can be performed in a different order and still achieve desirable results.

What is claimed is:

1. An ambidextrous shuttle spoon for a semiconductor wafer handling apparatus, the spoon comprising:
a first surface comprising a proximal mounting body portion and a semi-circular distal wafer support portion, the mounting body portion including one or more first mounting elements distributed thereon for coupling to a wafer handling system and the wafer support portion including a plurality of first support structures for supporting a wafer;
a second surface located on the first surface's underside and coextensive with the first surface, the second surface including second mounting elements substantially identical to the first mounting elements and second support structures substantially identical to the first support structures; and
where corresponding first and second mounting elements are in alignment with each other and corresponding first and second support structures are in alignment with each other.

2. The shuttle spoon of claim 1 where a mounting element includes one or more of: an alignment hole, a mounting hole, a raised edge, a protuberance, and a cavity.

3. The shuttle spoon of claim 1 where a support structure is a projection.

4. The shuttle spoon of claim 3 where the projection minimizes horizontal movement of a supported wafer relative to the shuttle spoon.

5. The shuttle spoon of claim 3 where the projection is a friction pad.

6. The shuttle spoon of claim 1 where the shuttle spoon is made of ceramic material, stainless steel, aluminum, graphite, tungsten, molybdenum or a polyimide.

7. The shuttle spoon of claim 1 where the shuttle spoon is made from a single piece of material.

8. The shuttle spoon of claim 1 where the shuttle spoon can be mounted to a semiconductor wafer handling apparatus using the first mounting elements or the second mounting elements.

9. An ambidextrous shuttle spoon for a semiconductor wafer handling apparatus, the spoon comprising:
a first surface comprising a proximal mounting body portion and a semi-circular distal wafer support portion, the mounting body portion including one or more first mounting elements distributed thereon for coupling to a wafer handling system and the wafer support portion including a plurality of first support structures for supporting a wafer; and
a second surface located on the first surface's underside and coextensive with the first surface, the second surface including second mounting elements substantially identical to the first mounting elements and second support structures substantially identical to the first support structures.

10. The shuttle spoon of claim 9 where corresponding first and second mounting elements are in alignment with each other and corresponding first and second support structures are in alignment with each other.

11. The shuttle spoon of claim 9 where a mounting element includes one or more of: an alignment hole, a mounting hole, a raised edge, a protuberance, and a cavity.

12. The shuttle spoon of claim 9 where a support structure is a projection.

13. The shuttle spoon of claim 12 where the projection minimizes horizontal movement of a supported wafer relative to the shuttle spoon.

14. The shuttle spoon of claim 12 where the projection is a friction pad.

15. The shuttle spoon of claim 9 where the shuttle spoon is made of ceramic material, stainless steel, aluminum, graphite, tungsten, molybdenum or a polyimide.

16. The shuttle spoon of claim 9 where the shuttle spoon is made from a single piece of material.

17. The shuttle spoon of claim 9 where the shuttle spoon can be mounted to a semiconductor wafer handling apparatus using the first mounting elements or the second mounting elements.
